(19) United States
(12) Patent Application Publication
(10) Pub. No.: US 2015/0259202 A1
(43) Pub. Date: Sep. 17, 2015

(54) Process for the Production of Synthesis Gas

(71) Applicant: HALDOR TOPSØE A/S, Kgs, Lyngby (DK)

(72) Inventors: Ib Dybkjær, Copenhagen (DK); Rachid Mabrouk, Munich (DE); Kim Aasberg-Petersen, Allerod (DK); Christian Niels Schjødt, Bronshoj (DK)

(73) Assignee: Haldor Topsøe A/S, Kgs. Lyngby (DK)

(21) Appl. No.: 14/434,462

(22) PCT Filed: Oct. 10, 2013
(86) PCT No.: PCT/EP2013/071113

§ 371 Date: Apr. 9, 2015

(30) Foreign Application Priority Data
Oct. 11, 2012 (EP) PCT/EP12/70133

(51) Int. Cl. C01B 3/48; C10G 2/00

(52) U.S. Cl. CPC C01B 3/48; C10G 2/30; C01B 2203/0244; C01B 2203/0261; C01B 2203/1076; C01B 2203/0283; C01B 2203/062; C01B 2203/142

(57) ABSTRACT

The invention relates to a process for the production of synthesis gas from tail gas including autothermal reforming and shifting a portion of autothermally reformed process gas in order to produce a product stream of synthesis gas richer in carbon monoxide.

The present invention relates to a process for the production of synthesis gas from the tail gas in plants for production of liquid hydrocarbons via Fischer-Tropsh synthesis. Particularly, the invention concerns the conversion of tail gas to synthesis gas in a Coal-to-Liquids (CTL) plant, where a primary synthesis gas is produced separately by partial oxidation of a solid carbonaceous feedstock such as coal, and where this primary synthesis gas has a H₂/CO molar ratio which is lower than that required by the Fischer-Tropsch synthesis section. The invention concerns also the conversion of tail gas to synthesis gas, where a primary synthesis gas is produced separately by autothermal reforming or catalytic partial oxidation of natural gas or by partial oxidation of natural gas or a solid carbonaceous feedstock such as coal. The synthesis gas produced in the tail gas section and the primary synthesis gas from partial oxidation may be combined to provide a product synthesis gas for said production of liquid hydrocarbons by Fischer-Tropsch synthesis.

As used herein “tail gas” means off-gas from the Fischer-Tropsch synthesis stage which is not re-used in said stage. Tail gas from Fischer-Tropsch synthesis is normally characterised by a low H₂/CO molar ratio (significantly lower than 2), a high CO concentration, a high concentration of methane, low concentrations of light paraffinic hydrocarbons such as ethane, propane and butane, and low concentrations of light olefins such as ethylene, propylene, and butylenes. The tail gas may also include alcohols and higher hydrocarbons. The content of water is usually lower than 2 wt %, e.g. lower than 1 or lower than 0.5 wt %.

It is known to treat tail gas in order to obtain a hydrogen containing gas. EP-A-1860063 discloses a process in which tail gas is treated separately by i.a. steam reforming or autothermal reforming in order to obtain a hydrogen containing mixture. Prior to passing the tail gas through such reforming, olefins in the tail gas are removed by passing the tail gas through a hydrogenation step and carbon monoxide is removed by also conducting a shift conversion under the addition of steam following the reaction CO+H₂O=H₂+CO₂. EP-A-1860063 also discloses the separate production of a primary synthesis gas by partial oxidation of coal (gasification). Since the H₂/CO molar ratio in this gas is normally below 1, this ratio is increased by the provision of a shift conversion under the addition of steam in order to approach the desired molar ratio of H₂/CO=2.0-2.5 required by Fischer-Tropsch synthesis following the reaction: CO+(2n+1)/n H₂=1/n (CₙH₂ₙ₊₂)+H₂O. To further control the H₂/CO molar ratio in the primary synthesis gas, only a part of this gas is shift converted. The synthesis gas produced in the tail gas treatment section can be combined with the resulting primary synthesis gas.

Similarly WO-A-04083342 discloses a process in which primary synthesis gas formed by catalytic partial oxidation of natural gas is divided to form a separate stream that passes through a plurality of shift reactors under the addition of steam in order to produce a hydrogen rich stream. This stream is then combined with the un-shifted primary synthesis gas. Thereby it is possible to adjust the hydrogen concentration in the synthesis gas stream used for Fischer-Tropsch synthesis. The adjustment can result in H₂/CO molar ratios from about 1.6 to about 10.

Patent application US 2008/0312347 discloses a process for synthesis gas production from a Fischer-Tropsch tail gas in which the tail gas is subjected to the successive steps of: shift conversion; carbon dioxide removal; dehydration; cryogenic separation of olefins, hydrogen and methane, where dried natural gas is also fed to this cryogenic separation stage; sulphur removal of the separated methane stream; steam reforming methane, and using the resulting synthesis gas in subsequent Fischer-Tropsch synthesis. This application also discloses that where steam reforming is partial oxidation reforming a water gas shift may be used on at least a portion of the synthesis gas from this reforming stage to increase the H₂/CO ratio.

Partial oxidation reforming refers to gasification, where reforming is conducted without the presence of any catalyst. Accordingly, US 2008/0312347 describes a process similar to EP-A-1860063 by disclosing the production of a primary synthesis gas for subsequent Fischer-Tropsch by partial oxidation of coal (gasification). Since the H₂/CO molar ratio in this primary synthesis gas is normally below 1, this ratio is increased by the provision of a shift conversion under the addition of steam in order to approach the desired molar ratio of H₂/CO=2.0-2.5 required by Fischer-Tropsch synthesis. To further control the H₂/CO molar ratio in such primary synthesis gas, only a part of this gas is shift converted. US 2008/0312347 is also silent about separate and independent production of a synthesis gas stream from tail gas.

WO-A-2011/112484 discloses a process consisting of two process lines. In one process line a hydrocarbon feed is mixed with Fischer-Tropsch tail gas and added to a steam methane reformer, partial oxidation reactor PDX or ATR. The effluent from the reformer is split in two streams; one goes directly to the second process line where it is mixed with synthesis gas from a PDX, while the other stream is partially shifted, combined with the non-shifted stream and finally also mixed witht the synthesis gas from the PDX in the second process line.

WO-A-2011/034932 discloses a process in which synthesis gas from a PDX reactor of a coal process line with downstream hydrocarbon synthesis process is partially shifted. The non-shifted portion of the synthesis gas is combined with reformed gas obtained from treating purge gas from said downstream hydrocarbon synthesis process.

US 2010/0298449 discloses a process for producing liquid hydrocarbons by Fischer-Tropsch synthesis (RFT) using a synthesis gas produced via partial oxidation (RPDX). Tail gas from Fischer-Tropsch is combined with a light feedstock and added to a steam methane reformer (RSMR). The effluent from the steam methane reformer is partially shifted (in unit RSC), then combined with the non-shifted portion and finally added to the synthesis gas produced via partial oxidation (RPDX).

It is an object of the present invention to provide a process for the production of synthesis gas from tail gas that enables a higher production of the desired product (carbon monoxide) which is particularly needed for downstream Fischer-Tropsch synthesis.

It is another object of the invention to reduce the oxygen consumption in the autothermal reformer of the tail gas treatment section of a plant for producing liquid hydrocarbons such as diesel and gasoline, in particular in a Coal-to-Liquids plant.

It is a further object to reduce the steam consumption in the shift conversion stage of the tail gas treatment section.

It is yet another object to reduce the size and cost of equipment downstream the autothermal reformer in the tail gas treatment section, or more generally in a tail gas treatment section.

These and other objects are solved by the present invention as defined by the following features in correspondence with the appended claims.

Features of the invention:

1. Process for the production of synthesis gas from a tail gas from a Fischer-Tropsch synthesis stage comprising:

(a) converting the tail gas into a process gas having a lower content of olefins and carbon monoxide;

(b) passing said process gas through an autothermal reforming stage or catalytic partial oxidation stage to produce a synthesis gas;

(c) forming a main synthesis gas stream and a by-pass gas stream by dividing the synthesis gas from the autothermal reforming stage or catalytic partial oxidation stage, and passing the by-pass gas stream through a shift conversion stage;

(d) forming a product stream of synthesis gas by combining the shifted by-pass gas stream with the main synthesis gas stream,

wherein at least a portion of said product stream of synthesis gas is combined with a separate product stream of primary synthesis gas resulting from the partial oxidation of natural gas or a solid carbonaceous feedstock, or primary synthesis gas resulting from autothermal reforming or catalytic partial oxidation of natural gas,

and the combined product stream of synthesis gas is converted to hydrocarbons via Fischer-Tropsch synthesis; and wherein step (a) comprises the steps:

passing the tail gas through a hydrogenation stage to produce a hydrogenated tail gas;

passing the hydrogenated tail gas through a shift conversion stage.

2. Process according to feature 1 wherein said separate product stream of primary synthesis gas resulting from the partial oxidation of a solid carbononaceous feedstock has been passed through a CO₂-removal stage.

3. Process according to feature 1 or 2 wherein step (a) comprises subjecting the tail gas to heat exchange reforming, tubular steam reforming or a combination of both.

4. Process according to feature 3 wherein the tail gas is subjected to heat exchange reforming, and where at least a portion of the produced synthesis gas from the autothermal reforming stage or catalytic partial oxidation of step (b) is used as heating medium in said heat exchange reforming.

5. Process according to anyone of the preceding features further comprising passing the shifted gas through a pre-reforming or methanation stage.

6. Process according to anyone of the preceding features wherein the hydrogenation stage is a dry gas hydrogenation.

As used herein the term “dry gas hydrogenation” means hydrogenation of tail gas comprising no addition of steam or water to the process.

7. Process according to anyone of the preceding features wherein the H₂/CO molar ratio in the product stream of synthesis gas is in the range 2.0 to 3.0, preferably 2.4-3.0.

8. Process according to any one of the preceding features wherein the H₂/CO molar ratio in the primary synthesis gas is 0.5-2.0, preferably 0.5-1.8.

9. Process according to anyone of the preceding features wherein the shift conversion stage after autothermal reforming or catalytic partial oxidation is conducted in a single shift reactor comprising a catalyst which in its active form comprises a mixture of zinc aluminium spinel and zinc oxide in combination with an alkali metal selected from the group consisting of Na, K, Rb, Cs and mixtures thereof.

10. Process according to feature 9 wherein the shift catalyst has a Zn/Al molar ratio in the range 0.5-1.0 and a content of alkali metal in the range 0.4 to 8.0 wt % based on the weight of oxidised catalyst.

11. Process according to features 9 or 10 further comprising adding steam or water to said shift conversion stage.

We have now found that by providing a shift step in a portion of the synthesis gas from autothermal reforming of the tail gas stream in the tail gas treatment section, a significant increase in the desired product (carbon monoxide) is obtained. At the same time, there is less oxygen and steam consumption in the autothermal reformer, and the volumetric flow of the effluent gas from the autothermal reformer is reduced thereby reducing size equipment downstream. Further the duty of the heater upstream the ATR in the tail gas section is significantly reduced.

Preferably, the tail gas from step (a) is not mixed with a different major hydrocarbon feedstock stream used in the preparation of primary synthesis gas such as a natural gas feed. Preferably the only hydrocarbon stream entering the hydrogenation stage of step (a) is said tail gas.

In principle, the adjustment of product gas composition, particularly the CO-content or H₂/CO molar ratio, in the product synthesis gas from the tail gas treatment section can also be done without the shift step in a portion of the synthesis gas from autothermal reforming by adjustment of the overall steam-to-carbon ratio upstream the autothermal reforming stage, for instance by adding steam to the autothermal reforming or by adding more steam to the shift after hydrogenation. However, this will seriously impair the process, since this also conveys the need of larger equipment downstream and more duty in the fired heater immediately upstream the autothermal reformer, as shown in the Example.

We have found that less carbon monoxide is removed by having a shift stage after autothermal reforming of the tail gas section than by having a shift stage in the primary synthesis gas section. Hence, in a sense the provision of shift conversion to a portion of the synthesis gas has been moved from the primary synthesis gas obtained from coal gasification as described in EP-A-1860063 or from natural gas as described in WO-A-04083342, to the synthesis gas obtained from the autothermal reforming in the tail gas treatment section of the plant. This is highly counter-intuitive because carbon monoxide, which is the desired product, is actually removed from the synthesis gas during shift conversion, yet a higher carbon monoxide production is nonetheless obtained in the synthesis gas compared to a situation where no shift is provided.

In a specific embodiment in connection with one or more of the above and below embodiments said separate product stream of primary synthesis gas resulting from the partial oxidation of natural gas or a solid carbonaceous feedstock has been passed through a CO₂-removal unit before being combined with the at least a portion of said product stream of synthesis gas which is produced from the tail gas.

The tail gas is hydrogenated before conducting the shift conversion stage. Such tail gas hydrogenation and methanation are preferably conducted in dedicated and separate units for respectively hydrogenation of olefins and pre-reforming or methanation, where the hydrogenated tail gas passes through shift conversion before entering the pre-reforming or methanation stage.

The provision of feature 4, which specifically combines the use of hydrogenator, shift, heat exchange reforming and autothermal reforming (or catalytic partial oxidation), where the hot effluent gas from the autothermal reformer or catalytic partial oxidation is used to heat the heat exchange reformer, enables even a higher production of carbon monoxide in the product stream of synthesis gas compared to a situation where the tail gas is hydrogenated, shifted and then passed to autothermal reforming (or catalytic partial oxidation) without using the hot effluent gas for heating the heat exchange reformer, optionally with the provision of pre-reforming or conducting a methanation step downstream said shift before conducting the reforming, as encompassed in feature 5.

In particular, the provision of pre-reforming or methanation according to feature 5 enables the reduction of higher hydrocarbons (C₂₊) still present in the gas thereby protecting the fired heater located downstream as well as the autothermal reformer or catalytic partial oxidation reactor.

The provision of a catalyst in the process according to feature 10 enables that the shift stage be conducted without the otherwise conventional addition of steam or water to the gas to be converted, or at least the shift can be operated under a low steam-to-carbon ratio thereby increasing energy efficiency and reducing the size of plant equipment, as evidenced in our U.S. Pat. No. 7,998,897.

The tail gas has preferably the composition in mol %: 10-25 H₂, 5-30 N₂, 10-25 CO, 20-30 CO₂, 10-20 methane, 0.1-0.9 ethane, 0.5-1.5 propylene, 0.1-0.8 propane, 0.1-0.9 n-butane, 0.1-0.8 n-pentane, 0.001-0.20 n-hexane, 0.001-0.09 h-heptane, 0.0010-0.020, 0.1-1.0 Ar.

The shift conversion stage after autothermal reforming or catalytic partial oxidation is preferably conducted in a single shift reactor comprising a catalyst which in its active form comprises a mixture of zinc aluminium spinel and zinc oxide in combination with an alkali metal selected from the group consisting of Na, K, Rb, Cs and mixtures thereof. More preferably the shift catalyst has a Zn/Al molar ratio in the range 0.5-1.0 and a content of alkali metal in the range 0.4 to 8.0 wt % based on the weight of oxidised catalyst.

In a specific embodiment in connection with any of the above embodiments, the shift conversion stage after the autohermal reforming or catalytic partial oxidation is conducted without the addition of steam or water.

In another specific embodiment, steam or water is added to said shift conversion state.

In yet another specific embodiment, the solid carbonaceous feedstock is selected from the group consisting of coal, biomass, coke, petcoke and combinations thereof.

The invention is further illustrated by reference to the accompanying drawings.

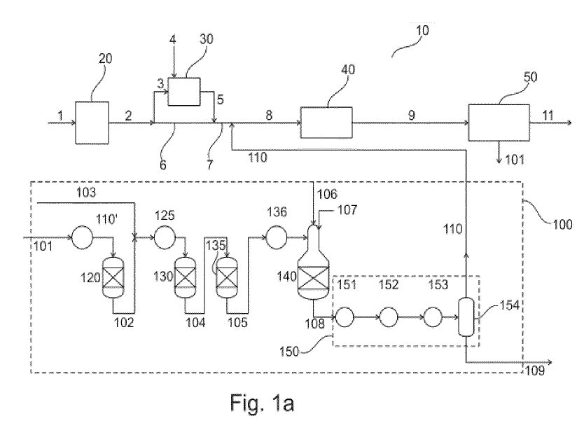

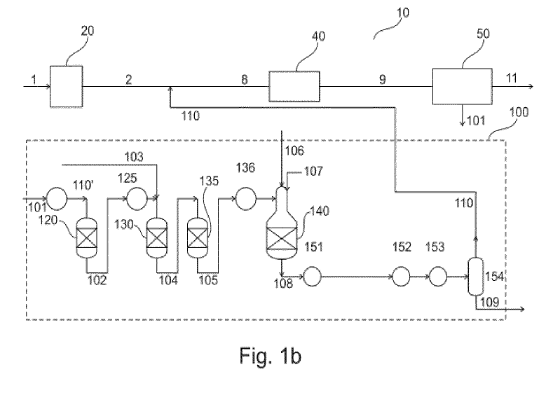

FIG. 1a shows a schematic view of a conventional process of a Coal-to-Liquid plant including tail gas treatment.

FIG. 1b shows a schematic view of an alternative conventional process of a Coal-to-Liquid plant including tail gas treatment.

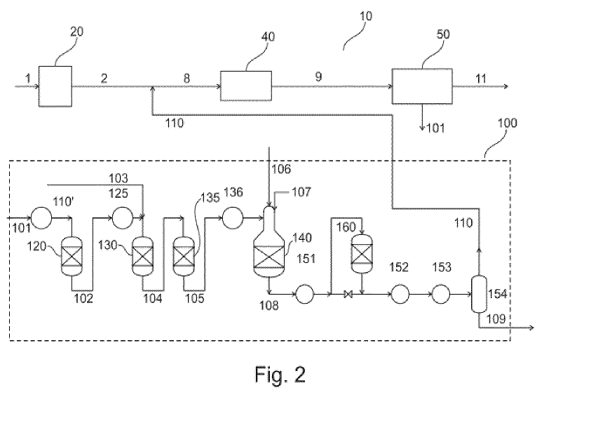

FIG. 2 shows a schematic view of a process of a Coal-to-Liquid plant including tail gas treatment according to an embodiment of the invention. The dotted line part of FIG. 2 shows in isolation a general embodiment in accordance with a second aspect of the invention.

The accompanying FIG. 1a shows a general schematic view of an embodiment for the production of synthesis gas via Fischer-Tropsch synthesis in a Coal-to-Liquids plant 10 according to the prior art. A solid carbonaceous feed 1 is partially oxidised in gasifier 20 and produces after further processing steps such as cooling, dry solids removal and gas scrubbing (not shown), a synthesis gas 2. The H₂/CO-molar ratio in synthesis gas 2 is normally well below 2, often about 1.6 or lower, for instance about 1 or 0.6. A portion 3 of this synthesis gas is by-passed and shifted in shift converter 30 under the addition of steam 4. The shifted stream 5 is then combined with the un-shifted stream of synthesis gas 6 to form primary synthesis gas stream 7. Primary synthesis gas stream is combined with synthesis gas from the tail gas treatment section 100 of the plant. The combined synthesis gas 8 is passed through CO₂-removal unit 40 and the resulting product stream of synthesis gas 9 having H₂/CO molar ratio of about 2 is then passed through Fischer-Tropsch synthesis stage 50 for production of liquid hydrocarbons 11. A tail gas stream 101 having a H₂/CO-molar ratio well below 2 is withdrawn from the Fischer-Tropsch stage 50 and passed through a hydrogenation catalyst in the presence of water/steam in hydrogenator 120. Olefins in the tail gas are thereby hydrogenated. This is necessary to control the temperature increase in the downstream shift reactor and to avoid carbon formation by cracking of the olefins on the nickel based catalyst of the downstream methanation reactor. Steam 103 is added to the hydrogenated tail gas 102 and then passed through a shift conversion stage 130 where carbon monoxide reacts with steam to produce hydrogen and carbon dioxide. Shifted stream 104 having a reduced amount of CO prevents carbon formation by CO-dissociation on the nickel based catalyst of downstream units. After shift the gas 104 is passed over a nickel based catalyst in methanation reactor 135, where the shift and methanation reactions are equilibrated and all higher hydrocarbons are removed. The purpose of the methanation is therefore to further reduce the CO concentration and to remove the higher hydrocarbons, thereby allowing preheating the gas 105 in heater 136 to a high temperature before entering the autothermal reformer (ATR) 140. In the ATR, the gas is reacted with oxygen 106 and steam 107 resulting in a hot effluent of synthesis gas 108, typically at 950-1100° C. The purpose of the ATR is to convert methane to synthesis gas and to establish equilibrium for the shift and methanation reactions at high temperature. The amount of steam added before the shift stage 130 is adjusted to obtain the desired H₂/CO molar ratio in the synthesis gas. Hot effluent synthesis gas 108 is withdrawn from the ATR 140 and passed to cooling train 150. Here the synthesis gas is cooled in a series of coolers 151-153 under the production of process condensate 109 in separator 154. The resulting synthesis gas 110 from the tail gas treatment section 100 is then combined with primary synthesis gas stream 7 of the Coal-to-Liquids process and further converted to liquid hydrocarbons 11 as described above.

FIG. 1b shows a general schematic view of an alternative embodiment for the production of synthesis gas via Fischer-Tropsch synthesis in a Coal-to-Liquids plant 10 according to the prior art. A solid carbonaceous feed 1 is partially oxidised in gasifier 20 and produces after further processing steps such as cooling, dry solids removal and gas scrubbing (not shown), a primary synthesis gas 2. The H₂/CO-molar ratio in synthesis gas 2 is normally well below 2, often about 1.6 or lower, for instance about 1 or 0.6. Primary synthesis gas stream is combined with synthesis gas from the tail gas treatment section 100 of the plant. The combined synthesis gas 8 is passed through CO₂-removal unit 40 and the resulting product stream of synthesis gas 9 having H₂/CO molar ratio of about 2 is then passed through Fischer-Tropsch synthesis stage 50 for production of liquid hydrocarbons 11. A tail gas stream 101 having a H₂/CO-molar ratio well below 2 is withdrawn from the Fischer-Tropsch stage 50 and passed through a hydrogenation catalyst in the presence of water/steam in hydrogenator 120. Olefins in the tail gas are thereby hydrogenated. This is necessary to control the temperature increase in the downstream shift reactor and to avoid carbon formation by cracking of the olefins on the nickel based catalyst of the downstream methanation reactor. Steam 103 is added to the hydrogenated tail gas 102 and then passed through a shift conversion stage 130 where carbon monoxide reacts with steam to produce hydrogen and carbon dioxide. Shifted stream 104 having a reduced amount of CO prevents carbon formation by CO-dissociation on the nickel based catalyst of downstream units. After shift the gas 104 is passed over a nickel based catalyst in methanation reactor 135, where the shift and methanation reactions are equilibrated and all higher hydrocarbons are removed. The purpose of the methanation is therefore to further reduce the CO concentration and to remove the higher hydrocarbons, thereby allowing preheating the gas 105 in heater 136 to a high temperature before entering the autothermal reformer (ATR) 140. In the ATR, the gas is reacted with oxygen 106 and steam 107 resulting in a hot effluent of synthesis gas 108, typically at 950-1100° C. The purpose of the ATR is to convert methane to synthesis gas and to establish equilibrium for the shift and methanation reactions at high temperature. Hot effluent synthesis gas 108 is withdrawn from the ATR 140 and passed to cooling train 150. Here the synthesis gas is cooled in a series of coolers 151-153 under the production of process condensate 109 in separator 154. The resulting synthesis gas 110 from the tail gas treatment section 100 is then combined with primary synthesis gas stream 7 of the Coal-to-Liquids process and further converted to liquid hydrocarbons 11 as described above. The amount of steam 103 added before the shift conversion stage 130 is adjusted to obtain a H₂/CO molar ratio of about 2 in the product stream of synthesis gas 9.

The process scheme according to one embodiment of the invention is shown in FIG. 2. In this case, the first part of the tail gas treatment section is as in FIG. 1b. However, the amount of steam added before the shift reactor 130 is now the minimum required to satisfy the need in the shift reactor 130, methanation reactor 135 and autothermal reformer 140. The carbon monoxide content in the synthesis gas from the ATR is on purpose reduced after cooling to a suitable temperature in downstream shift reactor 160. It has surprisingly been found that this carbon monoxide-reduction step actually increases the production of the desired product (kmol/hr of carbon monoxide) in the synthesis gas. At the same time it is possible to reduce the consumption of oxygen and steam, in addition to reducing the size and cost of equipment downstream the ATR 140, particularly the first boiler 151 used to cool the synthesis gas. Hence, energy efficiency is significantly improved.

More specifically, in FIG. 2 tail gas 101 is preheated in heater 110′ and olefins are hydrogenated in dry gas hydrogenator 120. The inlet temperature of the hydrogenator is adjusted to control the outlet temperature. After hydrogenation, the process gas 102 is preheated in heater 125, process steam 103 is added, and the gas is passed to shift reactor 130. The preheat temperature is adjusted to control the outlet temperature of the shift reactor. The shift converted gas 104 is passed to a methanation reactor (methanator) 135 where the shift and methanation reactions are equilibrated and all higher hydrocarbons are eliminated. After the methanator 135 the process gas 105 is preheated in heater 136. The preheated gas is further reacted with oxygen 106 and steam 107 in autothermal reformer 140. The hot effluent synthesis gas 108 from the ATR is cooled by steam production in boiler 151. This synthesis gas 108 is split into at least two streams. One stream is passed to shift conversion stage 160 for reduction of CO in the synthesis gas. The shift conversion 160 may be conducted without the addition of steam or with low steam-to-carbon ratio requirements compared to conventional shift reactors. One or more shift reactors can be used in shift conversion stage 160, for instance a high shift reactor followed by low shift reactor. The shifted gas from 160 is then combined with the un-shifted main synthesis gas stream from the ATR 140. The combined synthesis gas is finally cooled in coolers 152, 153 and process condensate separated as stream 109 in separator 154. The product synthesis gas 110 from the tail gas treatment section is exported and combined with primary synthesis gas 2 obtained from partial oxidation in gasifier 20 of coal feed 1. The combined synthesis gas 8 is then passed to CO₂-removal unit 40. The resulting product stream of synthesis gas 9 having H₂/CO molar ratio of about 2 is then passed through Fischer-Tropsch synthesis stage 50 for production of liquid hydrocarbons 11 and tail gas stream 101.

In a second aspect the invention encompasses also a process for the production of synthesis gas from a hydrocarbon feedstock, which in particular include tail gas from Fischer-Tropsch synthesis as described above, or tail gas from plants for production of gasoline by which synthesis gas is first converted to oxygenated compounds such as methanol and/or dimethyl ether and these are subsequently converted to gasoline, as for instance disclosed in our patents U.S. Pat. No. 4,520,216 and U.S. Pat. No. 4,481,305. The latter processes include the use of a gasoline reactor which produces a product effluent which is cooled to provide separate effluents of water, a tail gas which is rich in CO₂, as well as a liquid hydrocarbon phase of mixed gasoline and a light-end fraction in the form of LPG, i.e. raw product stream of gasoline or simply raw gasoline. The raw gasoline may be further processed by conventional means to obtain a lower-boiling gasoline fraction and the light-end fraction as LPG.

Hence, according to this second aspect the invention encompasses also a process for the production of synthesis gas from a hydrocarbon feedstock comprising:

(a) converting the hydrocarbon feedstock into a process gas having a lower content of olefins and carbon monoxide;

(b) passing said process gas through an autothermal reforming stage or catalytic partial oxidation stage to produce a synthesis gas;

(c) forming a main synthesis gas stream and a by-pass gas stream by dividing the synthesis gas from the autothermal reforming stage or catalytic partial oxidation stage, and passing the by-pass gas stream through a shift conversion stage;

(d) forming a product stream of synthesis gas by combining the shifted by-pass gas stream with the main synthesis gas stream;

and wherein step (a) comprises the steps:

passing the hydrocarbon feedstock through a hydrogenation stage to produce a hydrogenated tail gas;

passing the hydrogenated tail gas through a shift conversion stage.

In an embodiment in connection with one or more of the above or below embodiments of the second aspect of the invention, the hydrocarbon feedstock is tail gas from a Fischer-Tropsch synthesis stage, or tail gas from a gasoline reactor in a oxygenate-to-gasoline synthesis stage, where the oxygenate comprises methanol, dimethyl ether (DME) or combinations thereof.

Suitable said oxygenate-to-gasoline synthesis stage is a process according to patents U.S. Pat. No. 4,520,216 and U.S. Pat. No. 4,481,305.

It would be understood that in an oxygenate-to-gasoline synthesis stage, the gasoline reactor produces a product effluent which is cooled to provide separate effluents of water, a tail gas which is rich in CO₂, as well as a liquid hydrocarbon phase of mixed gasoline and a light-end fraction in the form of LPG, i.e. raw product stream of gasoline or simply raw gasoline. The raw gasoline may be further processed by conventional means to obtain a lower-boiling gasoline fraction and the light-end fraction as LPG.

The tail gas from a gasoline reactor in an oxygenate-to-gasoline synthesis stage in this second aspect of the invention comprises preferably H₂, CO, CO₂, N₂ and Ar, CH₄, C₃₋₄ constituents, and C₅H₁₂. In a particular embodiment the tail gas includes LPG and C₅ fractions which enables to produce a 100% C₅₊ and C₆₊ gasoline, respectively. A particular tail gas composition optionally including LPG and C₅ fractions comprises in mol %: 15-25 H₂, 15-25 CO, 17-25 CO₂, 7-12 N₂ plus Ar, 20-30 CH₄, 1-15 C₃₋₄ constituents, 0.5-8 C₅H₁₂. For instance a tail gas without LPG and C₅ fractions suitably has the composition 19 mol % Hₑᵣ 19 mol % CO, 21 mol % CO₂, 11 mol % N₂+Ar, 27 mol % CH₄, 2 mol % C₃₋₄ constituents and 1 mol % C₅H₁₂. A tail gas including C₅ fractions without LPG suitably has the composition 18 mol % H₂, 18 mol % CO, 20 mol % CO₂, 11 mol % N₂+Ar, 26 mol % CH₄, 2 mol % C₃₋₄ constituents and 5 mol % C₅H₁₂. A tail gas including C₅ fractions and LPG suitably has the composition: 16 mol % H₂, 16 mol % CO, 18 mol % CO₂, 9 mol % N₂+Ar, 23 mol % CH₄, 12 mol % C₃₋₄ constituents and 5 mol % C₅H₁₂.

A high energy efficiency in terms of lower oxygen consumption in the ATR or CPO as well as lower fired heater duty upstream the ATR or CPO is thus also obtained by the surprising use of such a tail gas from a gasoline reactor in a oxygenate-to-gasoline synthesis stage, optionally including LPG and C₅-fractions in the process in this second aspect of the invention.

Preferably, the tail gas from step (a) is not mixed with a different major hydrocarbon feedstock stream such as a natural gas feed which may also be used for the separate preparation of a primary synthesis gas. Preferably the only hydrocarbon stream entering the hydrogenation stage of step (a) is said tail gas.

In another embodiment in connection with one or more of the above or below embodiments of the second aspect of the invention, step (a) comprises subjecting the hydrocarbon feedstock to heat exchange reforming, tubular steam reforming or a combination of both.

In another embodiment in connection with one or more of the above or below embodiments of the second aspect of the invention, the hydrocarbon feedstock is subjected to heat exchange reforming, and at least a portion of the produced synthesis gas from the autothermal reforming stage or catalytic partial oxidation of step (b) is used as heating medium in said heat exchange reforming.

In another embodiment in connection with one or more of the above or below embodiments of the second aspect of the invention, the hydrogenation stage is a dry gas hydrogenation.

The term “dry gas hydrogenation” means hydrogenation of tail gas comprising no addition of steam or water to the process.

In another embodiment in connection with one or more of the above or below embodiments of the second aspect of the invention, the H₂/CO molar ratio in the product stream of synthesis gas is in the range 2.0 to 3.0, preferably 2.4-3.0.

In another embodiment in connection with one or more of the above or below embodiments of the second aspect of the invention, the H₂/CO molar ratio in the primary synthesis gas is 0.5-2.0, preferably 0.5-1.8.

In another embodiment in connection with one or more of the above or below embodiments of the second aspect of the invention, the shift conversion stage after autothermal reforming or catalytic partial oxidation is conducted in a single shift reactor comprising a catalyst which in its active form comprises a mixture of zinc aluminium spinel and zinc oxide in combination with an alkali metal selected from the group consisting of Na, K, Rb, Cs and mixtures thereof.

In another embodiment in connection with one or more of the above or below embodiments of the second aspect of the invention, the shift catalyst has a Zn/Al molar ratio in the range 0.5-1.0 and a content of alkali metal in the range 0.4 to 8.0 wt % based on the weight of oxidised catalyst.

In another embodiment in connection with one or more of the above or below embodiments of the second aspect of the invention, the process further comprises adding steam or water to said shift conversion stage.

### EXAMPLE

The example gives a comparison of results obtained in the case of conducting a process for production of synthesis gas from tail gas treatment (tail gas treatment section 100) according to the prior art, FIG. 1b, and a process according to one particular embodiment of the invention, FIG. 2. The results are shown in the table below.

It is seen that even though carbon monoxide is removed from the synthesis gas from the ATR because a portion of the gas is shift converted to carbon dioxide, the net result of carbon monoxide in the product synthesis gas stream 110 is higher (about 4%) compared to a situation where no shift is conducted after the ATR. This reflects in a significantly higher product value of the end product (liquid hydrocarbons).

At the same time, considerable savings are obtained in terms of oxygen and steam consumption as well as duty requirements. In particular, heater 136 upstream the ATR 140 is normally large thus requiring a heavy amount of duty, yet by the present invention the duty is more than halved (from about 80 to about 37 MW). Moreover, the exit flow from the ATR is reduced thereby reducing equipment size, particularly the size of boiler 151 (heat exchanger) downstream the ATR used to cool the produced synthesis gas. In other words, the invention enables a significant increase in energy efficiency.

| | FIG. 1b | FIG. 2 |
|---|---|---|
| | (prior art) | (invention) |
| Reforming technology | ATR | ATR |
| Shift 160 after ATR 140 | No | Yes |
| H₂/CO mol ratio in product stream | 2.7 vol. | 2.7 vol. |
| 110 | | |
| Pressure in product stream 110, | 28 | 28 |
| kg/cm² g | | |
| Steam/Dry Gas inlet Shift 125 | 1.75 | 0.815 |
| Steam added upstream Shift 125, | 23967 | 11434 |
| kmol/h | | |
| Inlet temp. process gas ATR, ° C. | 645 | 645 |
| Duty of heater 136, MW | 80.6 | 37.3 |
| CO in product stream 110, kmol/h | 6572 | 6825 |
| Oxygen consumption, MTPD | 4164 | 3943 |
| Flow exit ATR, stream 108, m³/s | 51.5 | 39.4 |
| Tail gas stream 101 (feed pr | 13973 | 14295 |
| line), kmol/h | | |
| Fuel gas (pr line), kmol/h | 601 | 279 |
| Total feed + fuel gas, kmol/h | 14574 | 14574 |
| Inlet temperature, methanator | 330 | 330 |
| 135, ° C. | | |
| Exit temperature methanator 135, | 479 | 541 |
| ° C. | | |
| Power from steam, MW | 61.4 | 74.7 |

The invention is also applicable to tail gas from the gasoline reactor of an oxygenate-to-gasoline synthesis stage according to the second aspect of the invention. In particular the tail gas optionally including LPG and C₅ fractions is introduced as stream 101 to the dotted line section of the process of FIG. 2. The invention enables also high energy efficiency when operating with this tail gas.

1. Process for the production of synthesis gas from a tail gas from a Fischer-Tropsch synthesis stage comprising:
(a) converting the tail gas into a process gas having a lower content of olefins and carbon monoxide;
(b) passing said process gas through an autothermal refoiniing stage or catalytic partial oxidation stage to produce a synthesis gas;
(c) forming a main synthesis gas stream and a by-pass gas stream by dividing the synthesis gas from the autothermal reforming stage or catalytic partial oxidation stage, and passing the by-pass gas stream through a shift conversion stage;
(d) forming a product stream of synthesis gas by combining the shifted by-pass gas stream with the main synthesis gas stream,
wherein at least a portion of said product stream of synthesis gas is combined with a separate product stream of primary synthesis gas resulting from the partial oxidation of natural gas or a solid carbonaceous feedstock, or primary synthesis gas resulting from autothermal reforming or catalytic partial oxidation of natural gas,
and the combined product stream of synthesis gas is converted to hydrocarbons via Fischer-Tropsch synthesis; and wherein step (a) comprises the steps:
passing the tail gas through a hydrogenation stage to produce a hydrogenated tail gas;
passing the hydrogenated tail gas through a shift conversion stage.

2. Process according to claim 1 wherein said separate product stream of primary synthesis gas resulting from the partial oxidation of a solid carbononaceous feedstock has been passed through a CO₂-removal stage.

3. Process according to claim 1 wherein step (a) comprises subjecting the tail gas to heat exchange reforming, tubular steam reforming or a combination of both.

4. Process according to claim 3 wherein the tail gas is subjected to heat exchange reforming, and where at least a portion of the produced synthesis gas from the autothermal reforming stage or catalytic partial oxidation of step (b) is used as heating medium in said heat exchange reforming.

5. Process according to claim 1 further comprising passing the shifted gas through a pre-reforming or methanation stage.

6. Process according to claim 1 wherein the hydrogenation stage is a dry gas hydrogenation.

7. Process according to claim 1 wherein the H₂/CO molar ratio in the product stream of synthesis gas is in the range 2.0 to 3.0, preferably 2.4-3.0.

8. Process according to claim 1 wherein the ¾/CO molar ratio in the primary synthesis gas is 0.5-2.0, preferably 0.5-1.8.

9. Process according to claim 1 wherein the shift conversion stage after autothermal reforming or catalytic partial oxidation is conducted in a single shift reactor comprising a catalyst which in its active form comprises a mixture of zinc aluminium spinel and zinc oxide in combination with an alkali metal selected from the group consisting of Na, K, Rb, Cs and mixtures thereof.

10. Process according to claim 9 wherein the shift catalyst has a Zn/Al molar ratio in the range 0.5-1.0 and a content of alkali metal in the range 0.4 to 8.0 wt % based on the weight of oxidised catalyst.

11. Process according to claim 9 further comprising adding steam or water to said shift conversion stage.
